(19) United States
(12) Patent Application Publication
(10) Pub. No.: US 2009/0309825 A1
(43) Pub. Date: Dec. 17, 2009

(54) USER INTERFACE, METHOD, AND COMPUTER PROGRAM FOR CONTROLLING APPARATUS, AND APPARATUS

(75) Inventors: Peter SODERGREN, Gantofta (SE); Mats LARSSON, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/138,834

(22) Filed: Jun. 13, 2008

(51) Int. Cl. G09G 5/00

(52) U.S. Cl. 345/156

(57) ABSTRACT

A user interface for a portable apparatus is disclosed. The user interface comprises a sensor arranged to determine a spatial change, wherein said user interface being arranged to control at least one function, wherein the function is controlled by said determined spatial change; an actuator arrangement; and at least one mass, wherein the actuator arrangement is arranged to controllably actuate at least one of the at least one mass by acceleration to by inertia of the actuated mass provide a force on the portable apparatus. Further, an apparatus, a method, and a computer program for controlling a function are disclosed.

### TECHNICAL FIELD

The present invention relates to a user interface, a method, and a computer program for controlling an apparatus, and such an apparatus.

### BACKGROUND

In the field of user operation of apparatuses, especially on small handheld apparatuses, e.g. mobile phones or portable media players having benefit of being operated, there is a problem of providing input means that can give the user a similar use experience as for larger stationary apparatuses since the small apparatus may not have room for input means having similar functions as provided by the larger apparatus. By input means, it is here meant units or aggregates that enable the user to input intentions by movements in one, two, or three dimensions. For the larger apparatuses, dedicated input units, such as joystick, steering wheel, or gaming console, may provide use experience both in complex mechanics for input of movements, and in feedback to user via servo mechanisms. A problem with this for small portable devices is that the user normally do not bring additional dedicated input units, and the embedded input means of the small portable device normally have constraints in size and power consumption. Therefore, there is a demand for an approach that overcomes at least some of these problems.

### SUMMARY

Therefore, the inventor has found an approach that both has low size requirements, and efficiently provides use experience also for small apparatuses. The basic understanding behind the invention is that this is possible if the user is provided to control functions by movement of the entire small apparatus, and wherein feedback to the user is provided by accelerating seismic masses in the apparatus. The inventor realized that a user is able to move the portable apparatus, which movement can be registered by the apparatus, e.g. by accelerometers, and the apparatus is able to react, counter-act, or in other ways affect input movements by controllably accelerating small masses in the apparatus. This can be performed in one, two, or three dimensions. Thus, the user can control one or more functions by movements and get movement feedback by using the entire body of the apparatus as input means.

According to a first aspect, there is provided user interface for a portable apparatus. The user interface comprises a sensor arranged to determine a spatial change, wherein said user interface being arranged to control at least one function, wherein the function is controlled by said determined spatial change; an actuator arrangement; and at least one mass, wherein the actuator arrangement is arranged to controllably actuate at least one of the at least one mass by acceleration to by inertia of the actuated mass provide a force on the portable apparatus.

According to a second aspect of the present invention, there is provided a portable apparatus comprising a processor and a user interface connected to the processor, wherein the user interface comprises a sensor arranged to determine a spatial change, wherein said user interface being arranged to provide input to said processor to control at least one function, wherein the function is controlled by said determined spatial change; an actuator arrangement controlled by the processor; and at least one mass, wherein the actuator arrangement is arranged to controllably actuate at least one of the at least one mass by acceleration to by inertia of the actuated mass provide a force on the portable apparatus.

The spatial change may comprise a linear movement the spatial change comprises a linear movement, a rotational movement, and/or a change in orientation.

The function may be control of a gaming parameter.

The sensor may be arranged to determine movements in one, two, or three dimensions. The actuator arrangement controllably actuating at least one of the at least one mass by acceleration may be arranged to apply the force on the portable apparatus, in one, two, or three dimensions.

The user interface may further comprise a gyroscope arranged to be controllably activated by the actuator arrangement to provide a reaction force on the portable apparatus upon change in orientation by an angular momentum.

The actuator arrangement and the at least one mass may be distributed within the portable apparatus to provide an aggregate force on the portable apparatus. The distribution of the actuator arrangement and the at least one mass within the portable apparatus may be distal from a mass centre of the portable apparatus.

According to a third aspect of the present invention, there is provided a user interface method comprising determining a spatial change; controlling a function based on the determined spatial change; and controllably actuating at least one mass by an actuator arrangement which is arranged to actuate at least one of the at least one mass by acceleration to, by inertia of the actuated mass, provide a force on the portable apparatus.

The determining of the spatial change may comprise determining a linear movement, a rotational movement, and/or a change in orientation.

The determination of movements by the sensor may be applied in one, two, or three dimensions. The controllably actuating by the actuator arrangement may be applied in one, two, or three dimensions.

The method may further comprise controllably activating a gyroscope by the actuator arrangement to provide a reaction force on the portable apparatus upon change in orientation by an angular momentum.

According to a fourth aspect of the present invention, there is provided a computer program comprising instructions, which when executed by a processor are arranged to cause the processor to perform the method according to the third aspect of the invention.

According to a fifth aspect of the present invention, there is provided a computer readable medium comprising program code, which when executed by a processor is arranged to cause the processor to perform the method according to the third aspect of the invention.

The computer readable medium comprises program code comprising instructions which when executed by a processor is arranged to cause the processor to perform determination of a spatial change; control of a function based on the determined spatial change; and controllable actuation of at least one mass by an actuator arrangement which is arranged to actuate at least one of the at least one mass by acceleration to, by inertia of the actuated mass, provide a force on the portable apparatus.

The program code instructions for determination of a spatial change may further be arranged to cause the processor to perform determination of a linear movement.

The program code instructions for determination of a spatial change may further be arranged to cause the processor to perform determination of a rotational movement.

The program code instructions for determination of a spatial change may further be arranged to cause the processor to perform determination of a change in orientation.

The program code instructions for determination of a spatial change may further be arranged to cause the processor to perform controllable activation of a gyroscope by the actuator arrangement to provide a reaction force on the portable apparatus upon change in orientation by an angular momentum.

### BRIEF DESCRIPTION OF DRAWINGS

FIGS. 1a to 1d illustrate a user interface according to embodiments of the present invention.

FIG. 2 illustrates a user interface according to an embodiment of the present invention.

FIG. 3 illustrates an assignment of directions for operation according to an embodiment of the present invention.

FIG. 4 is a block diagram schematically illustrating an apparatus according to an embodiment of the present invention.

FIG. 5 is a flow chart illustrating a method according to an embodiment of the present invention.

FIG. 6 schematically illustrates a computer program product according to an embodiment of the present invention.

### DETAILED DESCRIPTION OF EMBODIMENTS

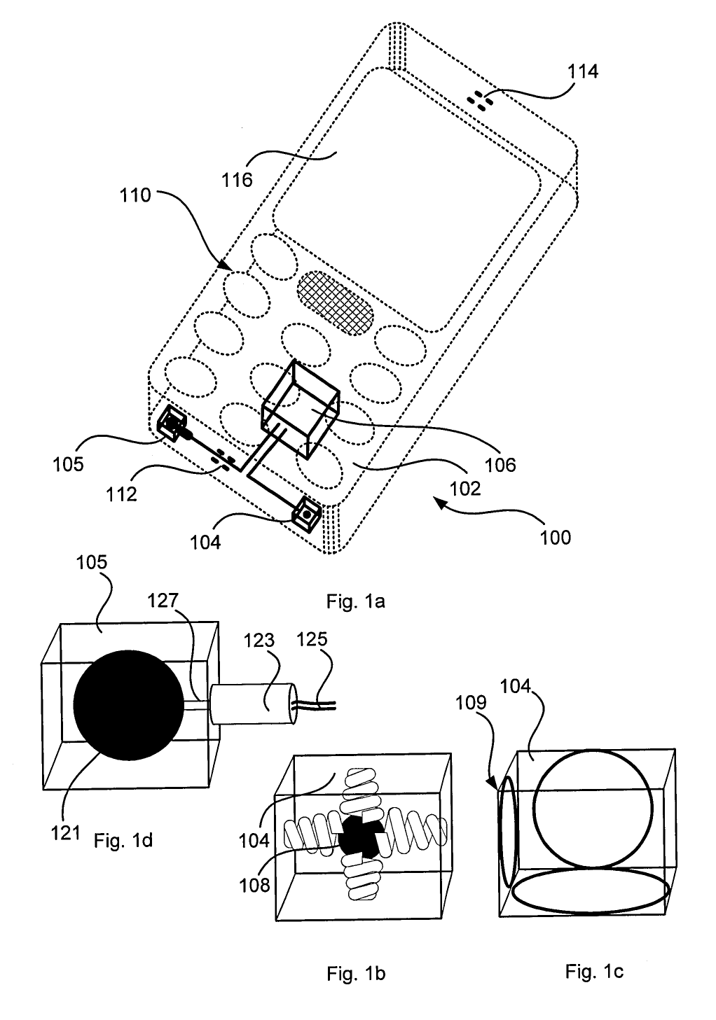

FIG. 1a illustrates a user interface 100 according to an embodiment of the present invention. The user interface 100 is illustrated in the context of a portable apparatus 102, drawn with dotted lines, holding an orientation sensor 104 of the user interface 100. The user interface 100 co-operates with a processor 106, which can be a separate processor of the user interface 100, or a general processor of the apparatus 102. The orientation sensor 104 can be a force sensor arranged to determine force applied to a seismic mass 108, e.g. integrated with the sensor 104, as schematically depicted magnified in FIG. 1b. By determining a direction and level of the force on the seismic mass 108, orientation and/or movement linearly or rotationally of the apparatus 102 can be determined. Alternatively, the orientation sensor 104 can be a gyroscopic sensor arranged to determine changes in orientation, e.g. a fibre optic gyroscope having fibre coils 109 in which light interference can occur based on movements, which then can be determined, as schematically depicted magnified in FIG. 1c. The orientation sensor 104 can be arranged to determine orientation in one or more dimensions. From the determined orientation and/or movement, user intentions can be derived, and control of functions, such as gaming parameters for control of a game upon playing a game on the portable apparatus 102, can be done accordingly without dedicated input units such as joystick, steering wheel or gaming console. In that way, a gaming control is provided to the user. For enhancing use experience, force feedback can be provided to the user by an actuator arrangement 105 which is arranged to actuate a mass 121 such that the inertia of the mass 121 will provide a force on the portable apparatus 102. The actuator arrangement can for example, as illustrated in FIG. 1d comprise a servo 123 controlled via electrical connection 125 to the processor 106. The servo 123 accelerates the mass 121 by a mechanical connection 127, whereby inertia of the mass provides the force on the portable apparatus 102, which is felt by the user holding the portable apparatus 102. The force can be applied in one or more dimensions, and can be provided by linear or rotational movement of the mass. Optionally, a gyroscope can be actuated such that a force on the portable apparatus 102 upon change in orientation is provided by an angular momentum. The gyroscopic effect can be provided by rotating a disc driven by an electric motor. This provides gyroscopic effect in two dimensions. For gyroscopic effect in more dimensions, further gyroscopes with different orientation can be provided, where the aggregate gyroscopic effect in different dimensions can be controllable by activating one or more of the gyroscopes.

By combination of accelerating one or more masses in selected directions or rotations, possibly together with applying gyroscopic effects in selected directions, a use experience can be provided such that, although the user only is turning or moving the portable apparatus 102, a force feedback experience in selected direction(s) is provided.

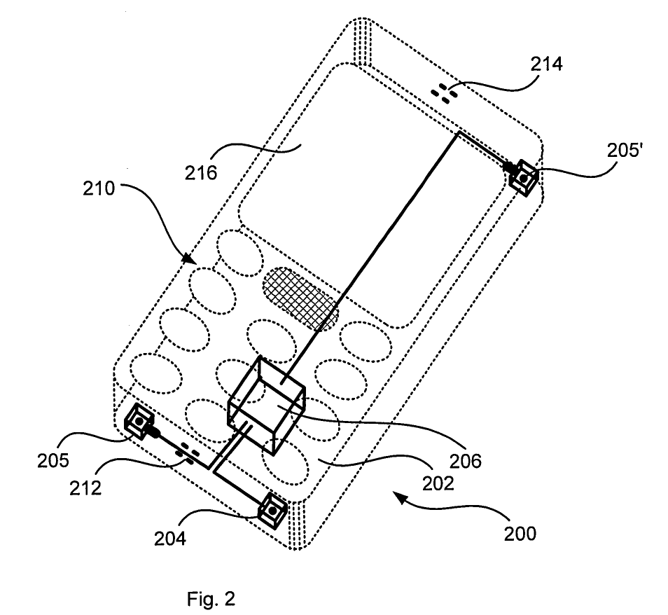

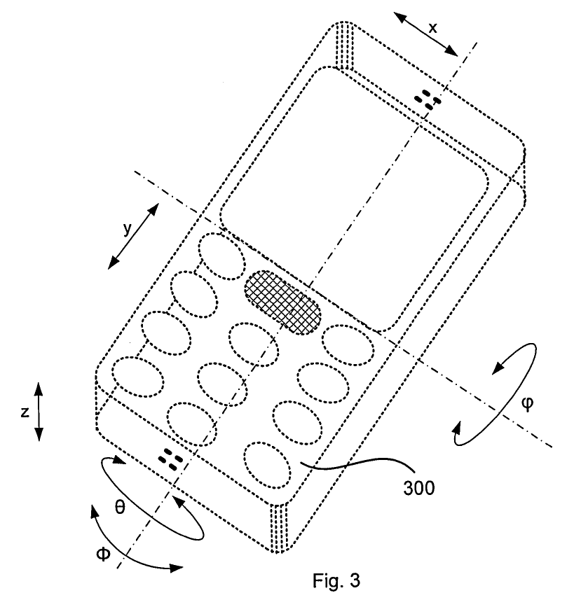

FIG. 2 illustrates a user interface 200 according to another embodiment of the present invention. The user interface 200 is illustrated in the context of an apparatus 202, drawn with dotted lines, holding the user interface 200. The user interface 200 comprises an orientation sensor 204, actuator arrangements 205, 205′, and a processor 206. Similar to the embodiment of FIG. 1, from orientation and/or movement, user intentions can be derived, and control of functions, such as gaming parameters, together with provision of force feedback. The provision of several actuators 205, 205′ is already suggested in the disclosure with reference to FIG. 1, but it has been found that by provision of several actuators 205, 205′, and arranging them distal from a mass centre of the portable apparatus 202, here given the example of providing them approximately in the opposite corners of the apparatus 202, provides an improved effect. It has also been found that by providing several actuators and together with masses to actuate, further dynamic experience of the force feedback can be provided, such as wave feelings, or providing a strong rotational force around especially a z-axis, as is defined in FIG. 3, of the portable apparatus 202.

It should be noted that an accelerometer based on gyroscopic effects, or equivalent functioning sensor e.g. using optics and light interference, e.g. ring laser gyroscope or fibre optic gyroscope, can be used, as well as a force sensor and seismic mass to detect changes in orientation in the embodiment illustrated in FIG. 2. The force applied on the portable apparatus 202 will be detected by these sensors, whereby an additional effect of detecting whether the portable apparatus is held firmly by the user or other means, which can be used both in gaming applications, as in other applications for determining use state of the portable apparatus 202.

The user interfaces 100, 200 may also comprise other elements, such as keys 110, 210, means for audio input and output 112, 114, 212, 214, image acquiring means (not shown), a display 116, 216, etc, respectively. The apparatuses 102, 202 may be a mobile telephone, a personal digital assistant, a navigator, a media player, a digital camera, or any other apparatus benefiting from a user interface according to any of the embodiments of the present invention.

Examples will be demonstrated below, but in general, the directions and/or movements can either be pre-set, or be user defined. In the latter case, a training mode can be provided where the user defines the directions and/or movements.

FIG. 3 illustrates assignments of changes in orientation and/or movements of an apparatus 300. The apparatus 300 is arranged with a user interface according to any of the embodiments demonstrated with reference to FIGS. 1 and 2. Movements can be determined from linear movements in any of the directions x, y or z, or any of them in combination. Movements can also be determined as change of orientation Φ, θ, or φ, or any combination of them. Combinations between linear movement(s) and change of orientation(s) can also be made. From this, one or more functions can be controlled. As an example, a function can be controlled in two steps: first a detection of a change in orientation and/or movement is determined for enabling the control of the function, e.g. a twist changing orientation θ or a back-and-forth movement along y, and second a determination of a change in orientation and/or movements for controlling the function, e.g. another twist changing orientation Φ or movement along x wherein a parameter of the function is changed according to the change in orientation Φ or movement along x. This sequence of change in orientation and/or movement can discriminate actual intentions to control the function from unintentional movements and changes in orientation of the apparatus 300 in certain applications. The provision of force on the portable apparatus 300 preferably uses the same scheme of directions and orientations. The apparatus 300 can for example be a mobile phone or a portable gaming apparatus. The application of force on the portable apparatus can be used for force feedback on corresponding input movements, but can also be provided to achieve other effects, such as making the phone rotate around its z-axis when positioned on a table, e.g. as a silent ring signal.

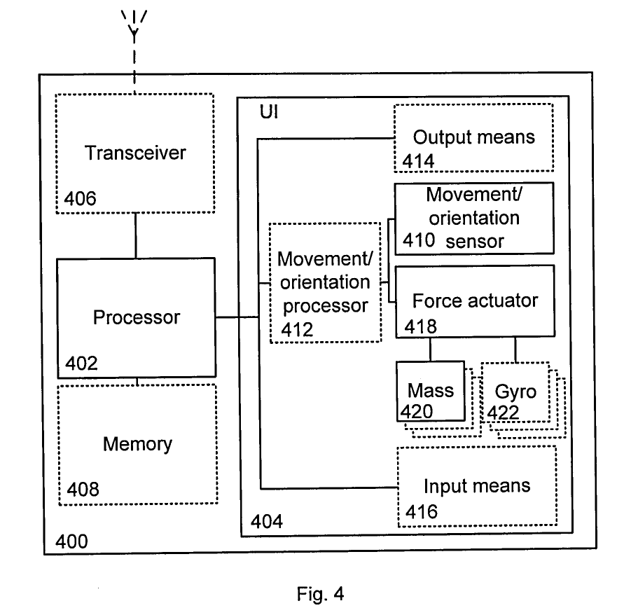

FIG. 4 is a block diagram schematically illustrating an apparatus 400 by its functional elements, i.e. the elements should be construed functionally and may each comprise one or more elements, or be integrated into each other. Broken line elements are optional and can be provided in any suitable constellation, depending on the purpose of the apparatus. In a basic set-up, the apparatus can work according to the principles of the invention with only the solid line elements. The apparatus 400 comprises a processor 402 and a user interface UI 404 being controlled by the processor 402 and providing user input to the processor 402. The apparatus 400 can also comprise a transceiver 406 for communicating with other entities, such as one or more other apparatuses and/or one or more communication networks, e.g. via radio signals. The transceiver 406 is preferably controlled by the processor 402 and provides received information to the processor 402. The transceiver 406 can be substituted with a receiver only, or a transmitter only where appropriate for the apparatus 400. The apparatus can also comprise one or more memories 408 arranged for storing computer program instructions for the processor 402, work data for the processor 402, and content data used by the apparatus 400.

The UI 404 comprises at least a sensor 410 arranged to determine movements and/or orientations of the apparatus 400. Output of the sensor can be handled by an optional movement/orientation processor 412, or directly by the processor 402 of the apparatus 400. Based on the output from the sensor 410, the apparatus 400 can be operated according to what has been demonstrated with reference to any of FIGS. 1 to 3 above. The UI 404 can also comprise output means 414, such as display, speaker, buzzer, and/or indicator lights. The UI 404 can also comprise other input means 416, such as microphone, key(s), jog dial, joystick, and/or touch sensitive input area. These optional input and output means are arranged to work according to their ordinary functions.

The apparatus 400 can be a mobile phone, a portable media player, or other portable device benefiting from the user interface features described above. The apparatus 400 can also be a portable handsfree device or a headset that is intended to be used together with any of the mobile phone, portable media player, or other portable device mentioned above, and for example being in communication with these devices via short range radio technology, such as Bluetooth wireless technology. For headsets or portable handsfree devices, the user interface described above is particularly useful, since these devices normally are even smaller.

The UI 404 further comprises a force actuator arrangement 418, which can comprise one or more servos operating a mass 420 or optionally a gyroscope 422. By control of the processor 402, or optionally by the movement and orientation processor 412, the actuator arrangement 418 actuates the mass(es) and/or the gyroscope(s) to provide force on the apparatus 400, as has been demonstrated with reference to FIGS. 1, 2 and 3.

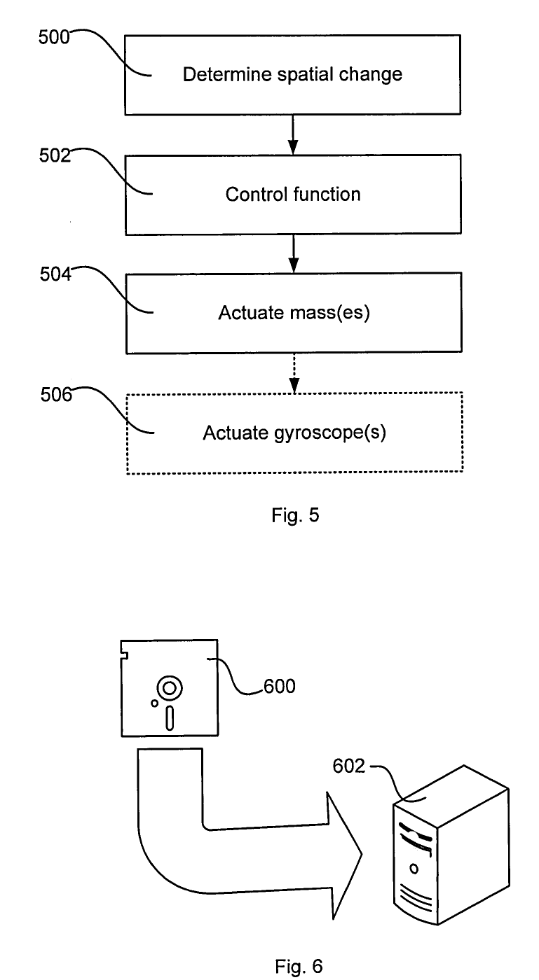

FIG. 5 is a flow chart illustrating a method according to an embodiment. The user interface method comprises determining 500 a spatial change. The determining of the spatial change can comprise determining a linear or rotational movement and/or a change in orientation. The method further comprises controlling 502 a function based on the determined spatial change. The controlling 502 of the function can for example be input of gaming parameters, but other input for controlling functions is equally possible. In a mass actuation step 504, at least one mass is actuated by an actuator arrangement arranged to actuate at least one of the at least one mass by acceleration to provide a force on the portable apparatus. This is possible due to the inertia of the actuated mass. By this selectable actuating on one or more masses, a desired force on the portable apparatus is achieved.

Optionally, in a gyroscope actuation step 506, a gyroscope of the portable apparatus is actuated, e.g. by rotating a disc of the gyroscope, for providing a force on the portable apparatus upon change in its orientation. This is possible due to an angular momentum of the gyroscope. One or more gyroscopes can be used, and if the gyroscopes are oriented in different directions, the gyroscopic effect, i.e. the angular momentum, in different directions can be controllable.

Upon performing the method, operation according to any of the examples given with reference to FIGS. 1 to 4 can be performed. The method according to the present invention is suitable for implementation with aid of processing means, such as computers and/or processors. Therefore, there is provided a computer program comprising instructions arranged to cause the processing means, processor, or computer to perform the steps of the method according to any of the embodiments described with reference to FIG. 5. The computer program preferably comprises program code which is stored on a computer readable medium 600, as illustrated in FIG. 6, which can be loaded and executed by a processing means, processor, or computer 602 to cause it to perform the method according to the present invention, preferably as any of the embodiments described with reference to FIG. 5. The computer 602 and computer program product 600 can be arranged to execute the program code sequentially where actions of the any of the methods are performed stepwise, but mostly be arranged to execute the program code on a real-time basis where actions of any of the methods are performed upon need and availability of data. The processing means, processor, or computer 602 is preferably what normally is referred to as an embedded system. Thus, the depicted computer readable medium 800 and computer 602 in FIG. 6 should be construed to be for illustrative purposes only to provide understanding of the principle, and not to be construed as any direct illustration of the elements.

1. A user interface for a portable apparatus, the user interface comprising a sensor arranged to determine a spatial change, wherein said user interface being arranged to control at least one function, wherein the function is controlled by said determined spatial change;
an actuator arrangement; and
at least one mass, wherein the actuator arrangement is arranged to controllably actuate at least one of the at least one mass by acceleration to by inertia of the actuated mass provide a force on the portable apparatus.

2. The user interface according to claim 1, wherein the spatial change comprises a linear movement.

3. The user interface according to claim 1, wherein the spatial change comprises a rotational movement.

4. The user interface according to claim 1, wherein said spatial change comprises a change in orientation.

5. The user interface according to claim 1, wherein said function is control of a gaming parameter.

6. The user interface according to claim 1, wherein the sensor is arranged to determine movements, and the actuator arrangement controllably actuating at least one of the at least one mass by acceleration is arranged to apply the force on the portable apparatus, in one, two, or three dimensions, respectively.

7. The user interface according to claim 1, further comprising a gyroscope arranged to be controllably activated by the actuator arrangement to provide a reaction force on the portable apparatus upon change in orientation by an angular momentum.

8. The user interface according to claim 1, wherein the actuator arrangement and the at least one mass are distributed within the portable apparatus to provide an aggregate force on the portable apparatus.

9. The user interface according to claim 8, wherein the distribution of the actuator arrangement and the at least one mass within the portable apparatus is distal from a mass centre of the portable apparatus.

10. A portable apparatus comprising a processor and a user interface connected to the processor, wherein the user interface comprises
a sensor arranged to determine a spatial change, wherein said user interface being arranged to provide input to said processor to control at least one function, wherein the function is controlled by said determined spatial change;
an actuator arrangement controlled by the processor; and
at least one mass, wherein the actuator arrangement is arranged to controllably actuate at least one of the at least one mass by acceleration to by inertia of the actuated mass provide a force on the portable apparatus

11. The apparatus according to claim 10, wherein said spatial change comprises a linear movement.

12. The apparatus according to claim 10, wherein the spatial change comprises a rotational movement.

13. The apparatus according to claim 10, wherein said spatial change comprises a change in orientation.

14. The apparatus according to claim 10, wherein said function is control of a gaming parameter.

15. The apparatus according to claim 10, wherein the sensor is arranged to determine movements, and the actuator arrangement controllably actuating at least one of the at least one mass by acceleration is arranged to apply the force on the portable apparatus, in one, two, or three dimensions, respectively.

16. The apparatus according to claim 10, further comprising a gyroscope arranged to be controllably activated by the actuator arrangement to provide a reaction force on the portable apparatus upon change in orientation by an angular momentum.

17. The apparatus according to claim 10, wherein the actuator arrangement and the at least one mass are distributed within the portable apparatus to provide an aggregate force on the portable apparatus.

18. The apparatus according to claim 17, wherein the distribution of the actuator arrangement and the at least one mass within the portable apparatus is distal from a mass centre of the portable apparatus.

19. A user interface method comprising
determining a spatial change;
controlling a function based on the determined spatial change; and
controllably actuating at least one mass by an actuator arrangement which is arranged to actuate at least one of the at least one mass by acceleration to, by inertia of the actuated mass, provide a force on the portable apparatus.

20. The method according to claim 19, wherein determining the spatial change comprises determining a linear movement.

21. The method according to claim 19, wherein determining the spatial change comprises determining a rotational movement.

22. The method according to claim 19, wherein determining the spatial change comprises determining a change in orientation.

23. The method according to claim 19, wherein the determination of movements by the sensor, and the controllably actuating by the actuator arrangement are applied in one, two, or three dimensions, respectively.

24. The method according to claim 19, further comprising controllably activating a gyroscope by the actuator arrangement to provide a reaction force on the portable apparatus upon change in orientation by an angular momentum.

25. A computer readable medium comprising program code comprising instructions which when executed by a processor is arranged to cause the processor to perform
determination of a spatial change;
control of a function based on the determined spatial change; and
controllable actuation of at least one mass by an actuator arrangement which is arranged to actuate at least one of the at least one mass by acceleration to, by inertia of the actuated mass, provide a force on the portable apparatus.

26. The computer readable medium according to claim 25, wherein the program code instructions for determination of a spatial change is further arranged to cause the processor to perform determination of a linear movement.

27. The computer readable medium according to claim 25, wherein the program code instructions for determination of a spatial change is further arranged to cause the processor to perform determination of a rotational movement.

28. The computer readable medium according to claim 25, wherein the program code instructions for determination of a spatial change is further arranged to cause the processor to perform determination of a change in orientation.

29. The computer readable medium according to claim 28, wherein the determination of movements by the sensor, and the controllably actuating by the actuator arrangement are applied in one, two, or three dimensions, respectively.

30. The computer readable medium according to claim 25, wherein the program code instructions for determination of a spatial change is further arranged to cause the processor to perform controllable activation of a gyroscope by the actuator arrangement to provide a reaction force on the portable apparatus upon change in orientation by an angular momentum.
